(19) United States
(12) Patent Application Publication
(10) Pub. No.: US 2019/0286024 A1
(43) Pub. Date: Sep. 19, 2019

(54) IMAGE FORMING APPARATUS AND FIXING METHOD

(71) Applicants: KABUSHIKI KAISHA TOSHIBA, Tokyo (JP); TOSHIBA TEC KABUSHIKI KAISHA, Tokyo (JP)

(72) Inventor: Keita UMEDA, Mishima Shizuoka (JP)

(73) Assignees: KABUSHIKI KAISHA TOSHIBA, Tokyo (JP); TOSHIBA TEC KABUSHIKI KAISHA, Tokyo (JP)

(21) Appl. No.: 16/248,662

(22) Filed: Jan. 15, 2019

Related U.S. Application Data
(62) Division of application No. 15/923,901, filed on Mar. 16, 2018.

(51) Int. Cl. G03G 15/20; G03G 15/00

(52) U.S. Cl. CPC G03G 15/2039; G03G 15/5004; G03G 15/2053

(57) ABSTRACT

An image forming apparatus includes: a fixing section for heating an image forming medium; a measuring section for measuring a temperature difference between a temperature of a first part of the fixing section and a temperature of a second part of the fixing section; a heater for heating the fixing section; a reflection section for reflecting radiation from the heater; a power output section for changing a degree of curvature of the reflection section; and a processor for controlling the power output section to change the degree of curvature so as to increase an amount of the radiation reflected by the reflection section and then applied to the first part if the temperature difference is equal to or greater than a first threshold value.

### FIELD

Embodiments described herein relate generally to an image forming apparatus and a fixing method.

### BACKGROUND

An image forming apparatus heats a toner image transferred onto a paper to fix the toner image on the paper. Therefore, as an example, in the image forming apparatus, a paper onto which the toner image is transferred passes between a heated fixing belt and a pressure roller. As a result, heat of a fixing belt is transferred to the paper and the toner image, and toner is melted due to the heat, thereby fixing the toner image on the paper. At this time, a temperature of the fixing belt decreases by an amount of heat transferred to the paper and the toner. The image forming apparatus can print on papers with various sizes. As the heat of the part of the fixing device through which the paper passes is transferred to the paper and the toner, when papers having a width smaller than the maximum printable width continuously pass through the fixing device, a temperature difference between the portion of the device where the paper passes on a surface of the fixing belt and a part where the paper does not pass gradually increases.

### DESCRIPTION OF THE DRAWINGS

FIG. 1 is a diagram illustrating an image forming apparatus according to a first embodiment and a second embodiment;

FIG. 2 is a perspective view illustrating a cross section of a fixing device of FIG. 1 in a radial direction;

FIG. 3 is a diagram illustrating a fixing device in a state where a reflector is not bent;

FIG. 4 is a diagram illustrating a fixing device in a state where the reflector is bent;

FIG. 5 is a block diagram illustrating the circuit configuration of a main part of the image forming apparatus according to the first embodiment and the second embodiment;

FIG. 6 is a flowchart of a process according to the first embodiment by a processor in FIG. 5; and

FIG. 7 is a flowchart of a process according to the second embodiment by the processor in FIG. 5.

### DETAILED DESCRIPTION

In accordance with an embodiment, an image forming apparatus comprises a fixing section configured to heat an image forming medium; a measuring section configured to measure a temperature difference between a temperature of a first part of the fixing section and a temperature of a second part of the fixing section; a heater configured to heat the fixing section; a reflection section configured to reflect radiation from the heater; a power output section configured to change a degree of curvature of the reflection section; and a processor configured to control the power output section to change the degree of curvature so as to increase an amount of the radiation reflected by the reflection section and then applied to the first part if the temperature difference is equal to or greater than a predetermined value.

Hereinafter, an image forming apparatus according to several embodiments will be described with reference to the accompanying drawings. In each figure used for the description of the following embodiments, a scale of each component may be appropriately changed in some cases. For the sake of explanation, configuration may be omitted in the figures used for the description of the following embodiments.

### First Embodiment

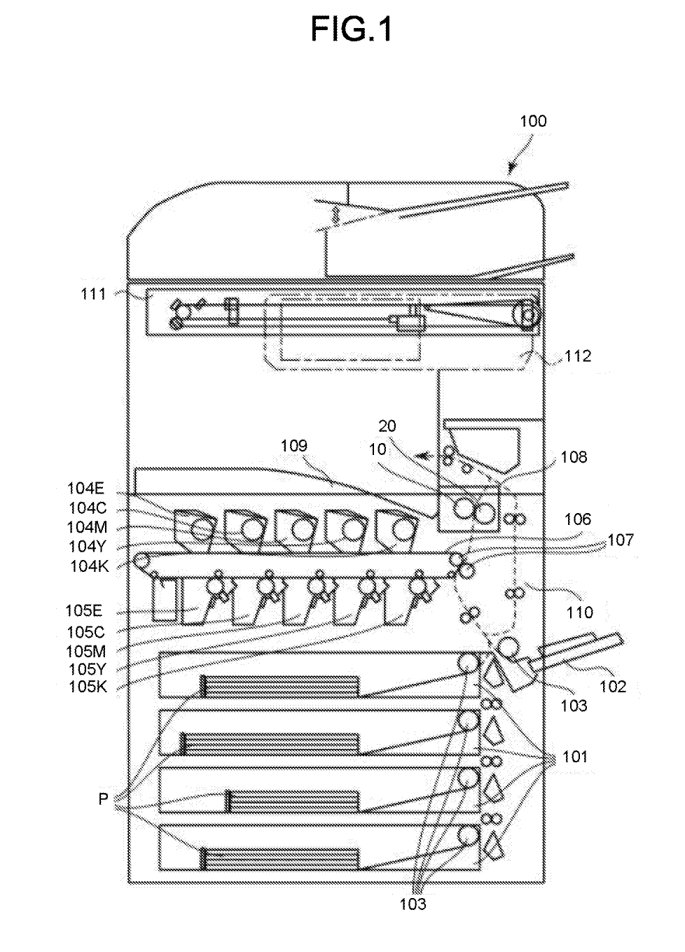

FIG. 1 is a diagram illustrating an image forming apparatus 100 according to the first embodiment. The image forming apparatus 100 is described with reference to FIG. 1.

The image forming apparatus 100 is, for example, an MFP (multifunction peripheral), a copy machine, a printer, a facsimile, or the like. The image forming apparatus 100 includes, for example, a printing function, a scanning function, a copying function, a decoloring function and a facsimile function. The printing function forms an image using a recording material such as toner on an image forming medium P. The image forming medium P is, for example, a sheet-like paper. The scanning function is used to read an image from a document on which the image is formed. The copying function is used to print an image read from a document by the scanning function on an image forming medium using a printing function. The decoloring function is used to decolor an image formed with a decolorable recording material on the image forming medium P. As an example, the image forming apparatus 100 comprises a paper feed tray 101, a manual feed tray 102, a paper feed roller 103, a toner cartridge 104, an image forming section 105, a transfer belt 106, a transfer roller 107, a fixing device 108, a paper discharge tray 109, a double-sided paper feed unit 110, a scan section 111 and a control panel 112.

The paper feed tray 101 accommodates the image forming medium P.

The manual feed tray 102 is used for manually inserting the image forming medium P.

The paper feed roller 103 rotates through an operation of a motor to convey image forming media accommodated in the paper feed tray 101 or the manual feed tray 102 one by one from the paper feed tray 101 or the manual feed tray 102.

The toner cartridge 104 stores a recording material such as the toner to be supplied to the image forming section 105. The image forming apparatus 100 includes one or a plurality of toner cartridges 104. As an example, the image forming apparatus 100 includes five toner cartridges 104, i.e., a toner cartridge 104C, a toner cartridge 104M, a toner cartridge 104Y, a toner cartridge 104K, and a toner cartridge 104E, as shown in FIG. 1. The toner cartridge 104C, the toner cartridge 104M, the toner cartridge 104Y and the toner cartridge 104K store recording material corresponding to respective colors CMYK (cyan, magenta, yellow, and key (black)). The toner cartridge 104E stores decolorable recording material decolored at a temperature higher than a predetermined temperature to be invisible. The color and type of the recording material stored in the toner cartridge 104 are not limited to those described here.

The image forming section 105 forms an image on the transfer belt 106 using the recording material supplied from the toner cartridge 104. The image forming apparatus 100 includes one or a plurality of image forming sections 105. As an example, as shown in FIG. 1, the image forming apparatus 100 includes five image forming sections 105, i.e., an image forming section 105E, an image forming section 105C, an image forming section 105M, an image forming section 105Y and an image forming section 105K. The image forming section 105C, the image forming section 105M, the image forming section 105Y and the image forming section 105K form images with recording materials corresponding to respective colors of CMYK, respectively. The image forming section 105E forms an image with a decolorable recording material.

The transfer belt 106 is, for example, an endless belt and is rotatable through an operation of a roller. The transfer belt 106 rotates to convey the images transferred from the image forming sections to a position of the transfer roller 107.

The transfer roller 107 includes two rollers facing each other. The transfer roller 107 transfers an image formed on the transfer belt 106 onto the image forming medium P passing between the transfer rollers 107.

The fixing device 108 heats and pressurizes the image forming medium P onto which the image has been transferred, thereby fixing the image transferred onto the image forming medium. The fixing device 108 includes a heating device 10 and a pressure roller 20.

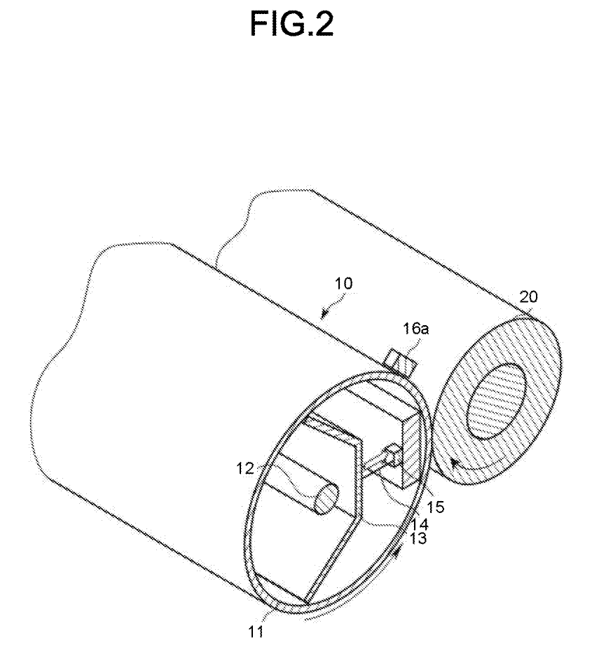

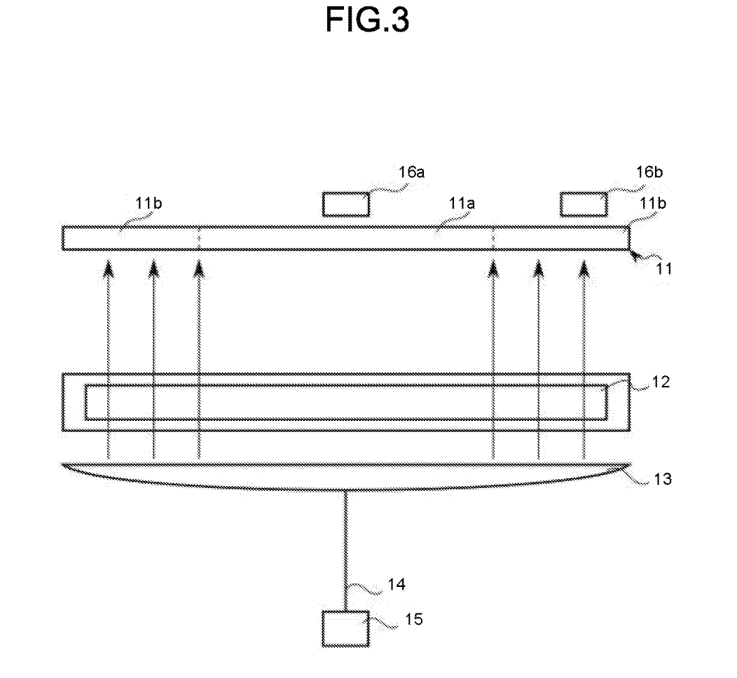

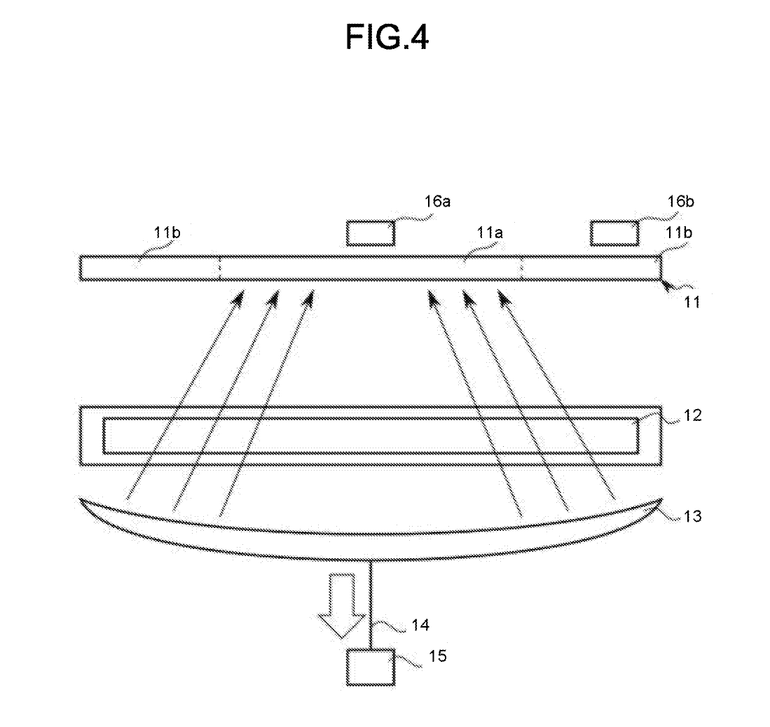

The fixing device 108 is described with reference to FIGS. 2 to 4. FIG. 2 is a perspective view illustrating a cross section cut along the radial direction of the heating device 10 and the pressure roller 20. A cutting position is about the center in a longitudinal direction of the heating device 10 and the pressure roller 20. In other words, the cutting position is a position where the center of the passing paper passes. FIG. 3 and FIG. 4 are diagrams illustrating the heating device 10.

The heating device 10 heats the image forming medium P. The heating device 10 includes, by way of example, a fixing belt 11, a heat source 12, a reflector 13, a tension section 14, a motor 15, a temperature sensor 16a and a temperature sensor 16b.

The fixing belt 11 is an endless belt rotatably provided. The fixing belt 11 heats the image forming medium P passing between the fixing belt 11 and the pressure roller 20. The fixing belt 11 is heated by the heat source 12. The fixing belt 11 is an example of a fixing section.

The heat source 12 heats the fixing belt 11 by thermal radiation or the like. Electromagnetic waves thermally radiated from the heat source 12 are applied to the fixing belt 11 and the reflector 13. The electromagnetic waves applied to the fixing belt 11 heat the fixing belt 11. The heat source 12 may heat the fixing belt 11 not only by the thermal radiation but also by thermal transmission and convection. The heat source 12 is an example of a heater that heats the fixing belt 11.

The reflector 13 reflects the electromagnetic waves radiated thermally from the heat source 12. The reflector 13 is provided so that the reflected electromagnetic waves are applied to the fixing belt 11. The reflector 13 is an example of a reflection section that reflects the radiation from the heat source 12.

The tension section 14 is a thread, a string or a bar connected to the center of the reflector 13.

The motor 15 is capable of pulling the tension section 14. When the tension section 14 is pulled, the reflector 13 connected with the tension section 14 curves. The motor 15 is an example of a power output section that changes a degree of curvature of the reflection section.

FIG. 3 shows a state in which the motor 15 does not pull the tension section 14. FIG. 4 shows a state in which the motor 15 is pulling the tension section 14. As is shown by comparing FIG. 3 with FIG. 4, the reflector 13 is bent when it is pulled by the tension section 14, and the pulled side is bent so as to form a convex shape. As a result, a reflection direction of the electromagnetic waves reflected by the reflector 13 after radiated from the heat source 12 changes from a direction shown by the plurality of arrows in FIG. 3 to a direction shown by the plurality of arrows in FIG. 4. In the state where the reflector 13 is bent, the amount of the electromagnetic waves reflected by the reflector 13 applied to end 11b decreases and the amount of the electromagnetic waves applied to a center 11a increases as compared with the state in which the reflector 13 is not bent. The reflector 13 is greatly bent as a pull force by the motor 15 is greater. The larger the curvature of the reflector 13 is, the smaller the amount of electromagnetic waves reflected by the reflector 13 applied to the end 11b becomes, and the amount applied to the central part 11a increases accordingly. A first part of the fixing belt 11 is the center 11a. A second part of the fixing belt 11 is the end 11b.

The temperature sensor 16a and the temperature sensor 16b measure the temperature of the fixing belt 11. Of them, the temperature sensor 16a measures the temperature of the center 11a of the fixing belt 11. Then, the temperature sensor 16b measures the temperature of the end lib of the fixing belt 11. The temperature sensor 16a and the temperature sensor 16b are, for example, thermistors.

For the sake of convenience, the temperature sensor 16a shown in FIGS. 3 and 4 is located at a position moved in a circumferential direction from the position of the temperature sensor 16a shown in FIG. 2. Similarly, the temperature sensor 16b is located at a position moved in the circumferential direction.

The pressure roller 20 presses the image forming medium P passing between the pressure roller 20 and the fixing belt 11.

The paper discharge tray 109 is a table to which the image forming medium P on which an image is printed is discharged.

The double-sided paper feed unit 110 enables the image forming medium P to be ready for printing on a back surface thereof. For example, the double-sided paper feed unit 110 reverses the front and back surfaces of the image forming medium P by switching back the image forming medium using a roller.

The scan section 111 reads an image from a document. The scan section 111 includes a scanner for reading an image from the document. For example, the scanner may be part of an optical reduction system including an image capturing element such as a CCD (charge-coupled device) image sensor. Alternatively, the scanner may be a CIS (contact image sensor) system including an image capturing element such as a CMOS (complementary metal-oxide-semiconductor) image sensor. Alternatively, the scanner may be a scanner of another known system.

The control panel 112 includes buttons and a touch panel to be operated by an operator of the image forming apparatus 100. The button and the touch panel function as an input device for receiving an operation by the operator of the image forming apparatus 100. Further, the touch panel functions as a display device for notifying the operator of the image forming apparatus 100 of various kinds of information.

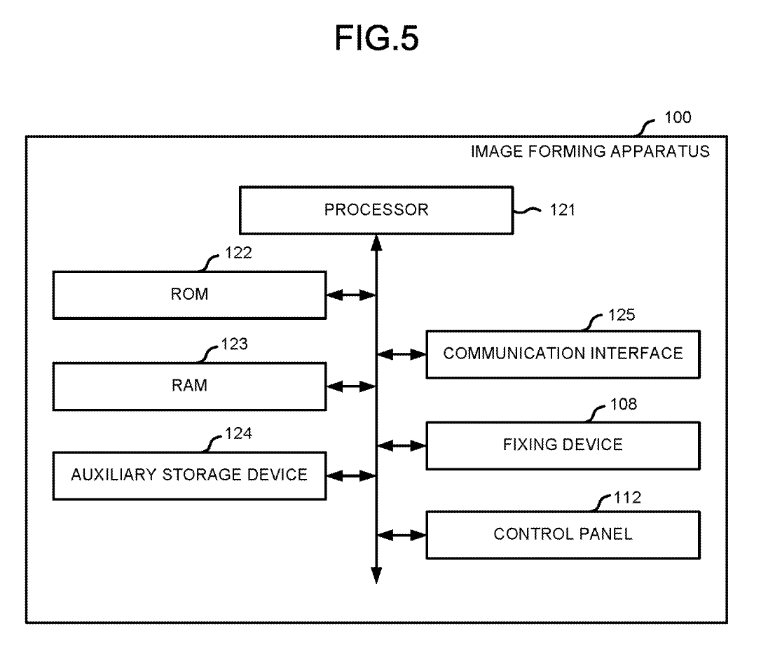

A circuit configuration of a main part of the image forming apparatus 100 is described with reference to FIG. 5. FIG. 5 is a block diagram illustrating an example of the circuit configuration of the main part of the image forming apparatus 100 according to the first embodiment.

As shown in FIG. 5, the image forming apparatus 100 includes, by way of example, a processor 121, a ROM (Read-Only Memory) 122, a RAM (Random-Access Memory) 123, an auxiliary storage device 124, a communication interface 125, a fixing device 108 and a control panel 112.

The processor 121 acts as a central part of a computer which executes a calculation process, a control process and other functions necessary for the operation of the image forming apparatus 100. The processor 121 controls each component to carry out various functions of the image forming apparatus 100 by executing programs such as system software, application software or firmware stored in the ROM 122 or the auxiliary storage device 124. The processor 121 is, for example, a CPU (Central Processing Unit), a MPU (Micro Processing Unit), a SoC (system on a Chip), a DSP (Digital Signal Processor), a GPU (Graphics Processing Unit), an ASIC (Application Specific Integrated Circuit), a PLD (Programmable Logic Device) or a FPGA (Field-Programmable Gate Array). Alternatively, the processor 121 may be a combination of these components.

The ROM 122 is one component of a main storage device of the computer with the processor 121 as a center. The ROM 122 is a nonvolatile memory exclusively used for reading data. The ROM 122 stores the above programs. The ROM 122 stores data used by the processor 121 for executing various processes or various setting values.

The RAM 123 is another component of the main storage device of the computer with the processor 121 as a center. The RAM 123 is a memory used for reading and writing data. The RAM 123 is used as a work area for storing data used temporarily in execution of various processes by the processor 121.

The auxiliary storage device 124 acts as an auxiliary storage device of the computer with the processor 121 as a center. The auxiliary storage device 124 is, for example, an EEPROM (electric erasable programmable read-only memory), a HDD (hard disk drive), a SSD (solid state drive), or the like. The auxiliary storage device 124 stores the above programs in some cases. The auxiliary storage device 124 stores data used by the processor 121 for executing various processes, data generated by the processes in the processor 121, various setting values, and the like. The image forming apparatus 100 may have an interface to which a storage medium such as a memory card or a USB (Universal Serial Bus) memory can be inserted instead of the auxiliary storage device 124 or in addition to the auxiliary storage device 124.

The programs stored in the ROM 122 or the auxiliary storage device 124 include a program for executing processes described later. As an example, the image forming apparatus 100 is delivered to an administrator of the image forming apparatus 100 in a state in which the program has been stored in the ROM 122 or the auxiliary storage device 124. However, the image forming apparatus 100 may be delivered to the administrator in a state in which the program has not been stored in the ROM 122 or the auxiliary storage device 124. The image forming apparatus 100 may be delivered to the administrator in a state in which another program which is different from the program has been stored in the ROM 122 or the auxiliary storage device 124. The program for executing the processes described later may be separately delivered to the administrator and written into the ROM 122 or the auxiliary storage device 124 under the operation of the administrator or a service person. At this time, the delivery of the program may be achieved by recording the program in a removable storage medium such as a magnetic disk, a magneto-optical disk, an optical disk, a semiconductor memory or the like, or by downloading it via a network NW.

The communication interface 125 is an interface through which the image forming apparatus 100 communicates with a PC (personal computer), a server, or the like via a network NW.

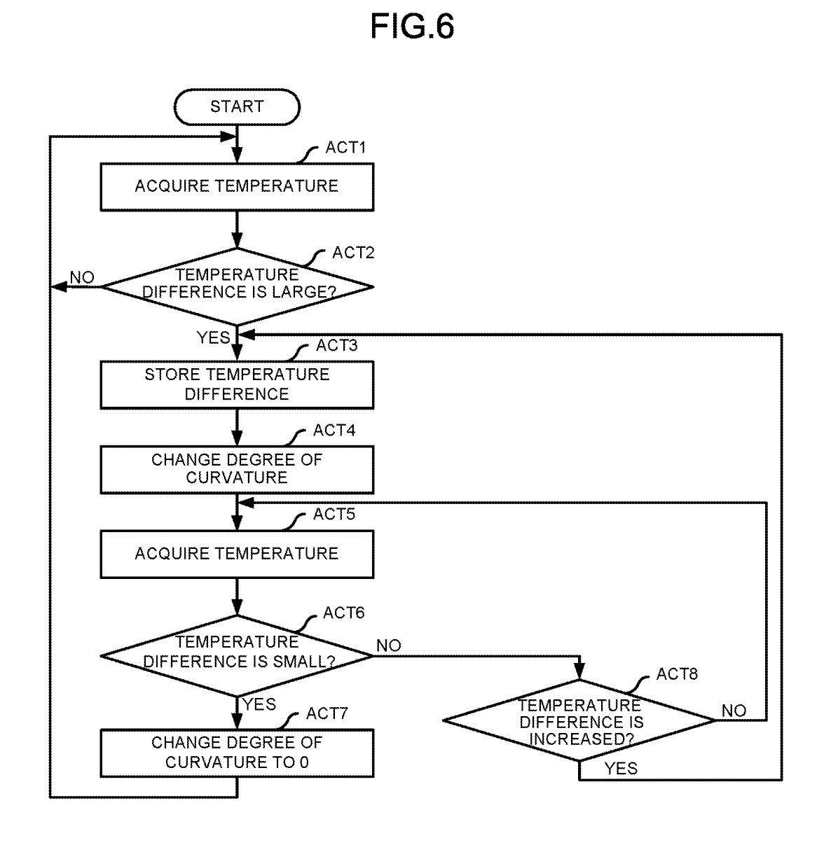

Below, the operation of the image forming apparatus 100 according to the first embodiment is described with reference to FIG. 6. The contents of the process in the following operation description are merely an example, and various processes capable of obtaining the same result can be suitably used. FIG. 6 is a flowchart of a process by the processor 121 of the image forming apparatus 100. The processor 121 executes this processing based on a program stored in the ROM 122 or the auxiliary storage device 124. If the processor 121 proceeds to a process in Act (N+1) after a process in Act N (N is a natural number), the description for explaining this may be omitted in some cases.

In Act 1 in FIG. 6, the processor 121 acquires the temperature measured by the temperature sensor 16a and the temperature sensor 16b. A temperature measured by the temperature sensor 16a is referred to as a central part temperature, and a temperature measured by the temperature sensor 16b is referred to as an end temperature.

In Act 2, the processor 121 determines whether or not a temperature difference obtained by subtracting the central part temperature acquired in Act 1 from the end temperature acquired in Act 1 is large (i.e., above a predetermined threshold value). The processor 121 determines whether or not the temperature difference is equal to or greater than a threshold value X1. If the temperature difference is less than the threshold value X1, the processor 121 determines No in Act 2 and returns to the process in Act 1. Thus, the processor 121 repeats the processes in Act 1 and Act 2 until the temperature difference is equal to or greater than the threshold value X1. The threshold value X1 is predetermined, for example, by a designer of the image forming apparatus 100. An administrator or a service person of the image forming apparatus 100 may set the threshold value X1.

As described above, the processor 121 acquires a temperature measured by the temperature sensor 16a and a temperature measured by the temperature sensor 16b to obtain a temperature difference obtained by subtracting the central part temperature from the end temperature. Thus, the processor 121, the temperature sensor 16a and the temperature sensor 16b cooperate with each other to function as a measuring section to measure the temperature difference. The threshold value X1 is an example of a first threshold value.

If the temperature difference is equal to or greater than the threshold value X1, the processor 121 determines Yes in Act 2 and proceeds to the process in Act 3.

In Act 3, the processor 121 stores the most recently derived temperature difference in the RAM 123. In the case in which the process in Act 3 is executed after the process in Act 2, in Act 3, the processor 121 stores the temperature difference obtained by subtracting the central part temperature acquired in Act 1 from the end temperature acquired in Act 1. If a temperature difference has been already stored in Act 3, the processor 121 overwrites and stores the temperature difference.

In Act 4, the processor 121 controls the fixing device 108 to change a degree of curvature of the reflector 13 in response to the temperature difference stored in Act 3. Here, the degree of curvature is a degree indicating how much the reflector 13 is bent. The processor 121 increases the degree of curvature of the reflector 13 as the temperature difference stored in Act 3 becomes larger. For example, if the temperature difference stored in Act 3 is equal to or greater than the threshold value X1 and less than a threshold value X2, the processor 121 sets the degree of curvature to 1; if the temperature difference is equal to or greater than the threshold value X2 and smaller than a threshold value X3, the processor 121 sets the degree of curvature to 2; if the temperature difference is equal to or greater than the threshold value X3 and smaller than a threshold value X4, the processor 121 sets the degree of curvature to 3, and so on. The larger the value of the degree of curvature is, the more the reflector 13 is bent. The degree of curvature of the reflector 13 is set to 0 when the motor 15 is not pulling the tension section 14. The threshold value X1, the threshold value X2, the threshold value X3, etc. have a relationship such that: the threshold value X1<the threshold value X2<the threshold value X3, and so forth. These threshold values are determined in advance by, for example, the designer of the image forming apparatus 100. An administrator or a service person of the image forming apparatus 100 may set those threshold values. A change in the degree of curvature can be controlled, for example, by changing an amount by which the motor 15 pulls the tension section 14. The maximum value of the degree of curvature is determined by, for example, the designer of the image forming apparatus 100. As an example, the maximum value of the degree of curvature is 6. In this case, the degree of curvature has seven levels from 0 to 6. The amount by which the motor 15 pulls the tension section 14 is, by way of example, a degree of curvature*4.5 mm. The degree of curvature is not limited to having seven levels. The degree of curvature may be continuous.

As described above, by changing the degree of curvature from 0 to 1 or more, an amount of heat applied to the central part 11a increases and an amount of heat applied to the end 11b decreases.

In Act 5, the processor 121 acquires the central part temperature and the end temperature.

In Act 6, the processor 121 determines whether or not a temperature difference obtained by subtracting the central part temperature acquired in Act 5 from the end temperature acquired in Act 5 becomes smaller than the temperature difference obtained by subtracting the central part temperature acquired in Act 1 from the end temperature acquired in Act 1. The processor 121 determines whether or not the temperature difference is less than a threshold value X0. A magnitude relationship between the threshold value X0 and the threshold value X1 is: the threshold value X0≤the threshold value X1. If the temperature difference is less than the threshold value X0, the processor 121 determines Yes in Act 6 and proceeds to the process in Act 7.

In Act 7, the processor 121 controls the fixing device 108 to change the degree of curvature of the reflector 13 to 0. The processor 121 returns to the process in Act 1 after the process in Act 7.

On the other hand, if the temperature difference is equal to or greater than the threshold value X0, the processor 121 determines No in Act 6 and proceeds to the process in Act 8.

In Act 8, the processor 121 determines whether or not the temperature difference obtained by subtracting the central part temperature from the end temperature increases. For example, if the temperature difference obtained by subtracting the central part temperature acquired in Act 5 from the end temperature acquired in Act 5 is larger than the temperature difference stored in Act 3 by a threshold value W or more, the processor 121 determines that the temperature difference increases. The threshold value W is predetermined, for example, by the designer of the image forming apparatus 100. An administrator or a service person of the image forming apparatus 100 may set the threshold value W. For example, when the temperature difference stored in Act 3 is equal to or greater than a threshold value Xn and less than a threshold value X(n+1), if the temperature difference obtained by subtracting the central part temperature acquired in Act 5 from the end temperature acquired in Act 5 is equal to or greater than a threshold value X(n+k), the processor 121 determines that the temperature difference increases. n and k are natural numbers, respectively. k is, for example, 1. As an example, n=1 and k=1. In this case, the temperature difference stored in Act 3 is equal to or greater than the threshold value X1 and less than the threshold value X2. Then, the processor 121 determines that the temperature difference increases if the temperature difference obtained by subtracting the central part temperature acquired in Act 5 from the end temperature acquired in Act 5 is equal to or greater than the threshold value X2. If the processor 121 determines that the temperature difference increases, the processor 121 determines Yes in Act 8 and returns to the process in Act 3.

When returning from the process in Act 8 to the process in Act 3, in Act 3, the processor 121 stores the temperature difference obtained by subtracting the central part temperature acquired in Act 5 from the end temperature acquired in Act 5.

On the other hand, if the processor 121 determines that the temperature difference does not increase, the processor 121 determines No in Act 8 and returns to the process in Act 5.

In the image forming apparatus 100 according to the first embodiment, if the temperature difference obtained by subtracting the central part temperature from the end temperature is equal to or greater than the threshold value X1, the reflector 13 is bent to increase the degree of curvature thereof. As a result, the amount of heat applied to the central part 11a increases, and the amount of heat applied to the end 11b decreases. In this manner, the image forming apparatus 100 of the first embodiment can reduce the temperature difference between the central part 11a and the end 11b.

The image forming apparatus 100 of the first embodiment further increases the degree of curvature if the temperature difference obtained by subtracting the central part temperature from the end temperature increases in a state in which the degree of curvature is changed in Act 4. As a result, the image forming apparatus 100 of the first embodiment can reduce the temperature difference between the central part 11a and the end 11b.

### Second Embodiment

The configuration of the image forming apparatus 100 of the second embodiment is the same as that of the first embodiment, so the description thereof is omitted.

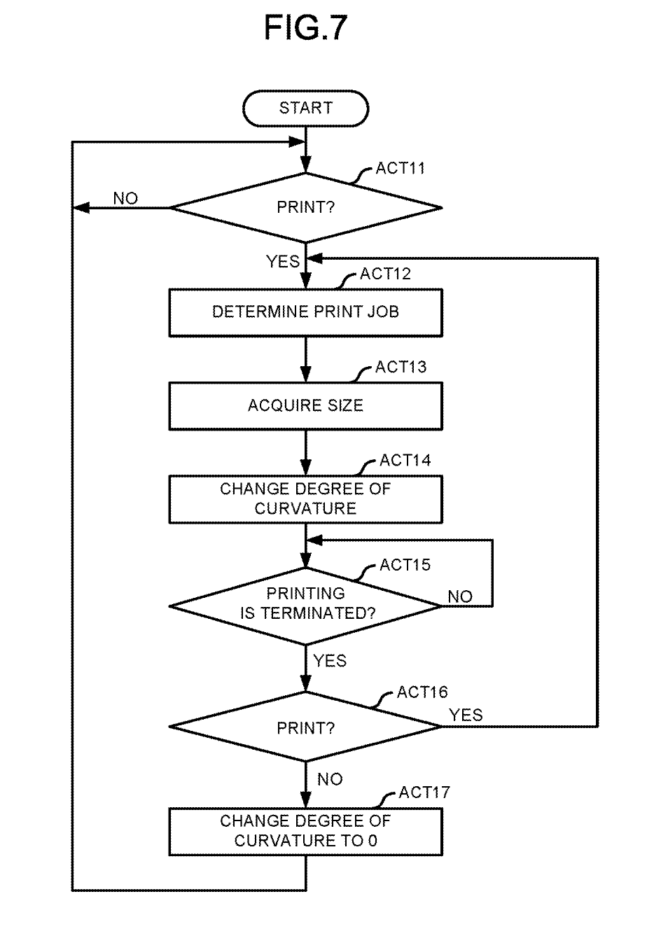

Below, the operation of the image forming apparatus 100 according to the second embodiment is described with reference to FIG. 7. The contents of the process in the following operation description are merely an example, and various processes capable of obtaining the same result can be suitably used. FIG. 7 is a flowchart of a process by the processor 121 of the image forming apparatus 100. The processor 121 executes this process by executing a program stored in the ROM 122 or the auxiliary storage device 124.

In Act 11, the processor 121 determines whether to start printing. For example, the processor 121 starts printing if there is an unexecuted print job. If there is no unexecuted print job, the processor 121 determines No in Act 11 and repeats the process in Act 11. Thus, if there is no unexecuted print job, the processor 121 repeats the process in Act 11 until a print job is added. If the printing is started, the processor 121 determines Yes in Act 11 and proceeds to the process in Act 12.

In Act 12, the processor 121 determines the print job to be started. For example, the processor 121 determines the earliest print job in the unexecuted print jobs as a print job to be started.

In Act 13, the processor 121 refers to the print job determined in Act 12 and acquires a size of the image forming medium P to be printed which is designated in the print job.

In Act 14, the processor 121 controls the fixing device 108 to change the degree of curvature of the reflector 13 in response to the size acquired in Act 13. The degree of curvature is, for example, shown in Table 1 below. If the width of the paper is the maximum printable width or close to it, the degree of curvature is 0, for example. The smaller the width of the paper becomes, the greater the degree of curvature is.

TABLE 1

| | | Vertical (length | Degree of |
|---|---|---|---|
| Paper | Horizontal | in conveyance | curvature of |
| size | (width) [mm] | direction) [mm] | reflector |
| A3 | 297 | 420 | 0 |
| A4 | 297 | 210 | 0 |
| LT | 279.4 | 215.9 | 1 |
| LD | 279.4 | 431.8 | 1 |
| B4 | 257 | 364 | 2 |
| LT-R | 215.9 | 279.4 | 3 |
| LG | 215.9 | 355.6 | 3 |
| ST | 215.9 | 139.7 | 3 |
| A4-R | 210 | 297 | 4 |
| A5 | 210 | 148 | 4 |
| B5-R | 182 | 257 | 5 |
| A5-R | 148 | 310 | 6 |
| ST-R | 139.7 | 215.9 | 6 |

In Act 15, the processor 121 stands by until the printing based on the print job determined in Act 12 is terminated. Upon completion of the printing, the processor 121 determines Yes in Act 15 and proceeds to the process in Act 16.

In Act 16, the processor 121 determines whether to start a next printing. For example, the processor 121 starts the next printing if there is an unexecuted print job. If the processor 121 starts the next printing, the processor 121 determines Yes in Act 16 and proceeds to the process in Act 12. On the other hand, if the next print job is not started, the processor 121 determines No in Act 16 and proceeds to the process in Act 17.

In Act 17, the processor 121 controls the fixing device 108 to change the degree of curvature of the reflector 13 to 0. The processor 121 returns to the process in Act 11 after the processing in Act 17.

In the image forming apparatus 100 of the second embodiment, the reflector 13 is bent in such a manner that the degree of curvature of the reflector 13 becomes larger as the width of the image forming medium P to be printed is smaller. Thus, in the image forming apparatus 100 of the second embodiment, the temperature difference between the central part 11a and the end 11b can be reduced.

The above first and second embodiments can also be modified as follows.

The image forming apparatus 100 of the first embodiment may change the degree of curvature to a larger value if the temperature difference obtained by subtracting the central part temperature from the end temperature is not reduced even if the degree of curvature is changed in Act 4. For example, the processor 121 changes the degree of curvature to a larger value if a difference between the temperature difference obtained by subtracting the central part temperature acquired in Act 5 from the end temperature acquired in Act 5 and the temperature difference stored in Act 3 is lower than a predetermined value. By doing this, the image forming apparatus 100 can reduce f the temperature difference between the central part 11a and the end 11b.

The image forming apparatus 100 of the second embodiment may determine the degree of curvature according to the number of the image forming media P passing through the fixing device 108. For example, the processor 121 of the image forming apparatus 100 reduces the degree of curvature shown in Table 1 if the number of the image forming media P used in a print job determined in Act 12 is smaller than a threshold value Y1. Then, the processor 121 increases the degree of curvature shown in Table 1 if the number of the image forming media is larger than a threshold value Y2. The magnitude relationship between the threshold value Y1 and the threshold value Y2 is Y1<Y2. Alternatively, the processor 121 may determine the degree of curvature according to a function of the number of the image forming media. If a plurality of print jobs are executed consecutively, the processor 121 may sum the number of the image forming media P used in a plurality of print jobs. The threshold value Y1 and the threshold value Y2 are predetermined, for example, by the designer of the image forming apparatus 100. An administrator or a service person of the image forming apparatus 100 may set the threshold value Y1 and the threshold value Y2.

The image forming apparatus 100 of the second embodiment may measure a temperature difference obtained by subtracting the central part temperature from the end temperature after changing the degree of curvature in Act 14. The image forming apparatus 100 may change the degree of curvature according to the temperature difference. For example, the processor 121 increases the degree of curvature if the temperature difference is equal to or greater than a threshold value Z1. By doing this, the image forming apparatus 100 can reduce the temperature difference between the central part 11a and the end 11b. For example, the processor 121 reduces the degree of curvature if the temperature difference is equal to or smaller than a threshold value Z2. Alternatively, the processor 121 may set the degree of curvature to 0. By doing so, the image forming apparatus 100 can prevent the temperature of the central part from becoming too high compared with the end. The threshold value Z1 and the threshold value Z2 are predetermined, for example, by the designer of the image forming apparatus 100. An administrator or a service person of the image forming apparatus 100 may set the threshold value Z1 and the threshold value Z2. The threshold value Z1 is an example of a second threshold value. The threshold value Z2 is an example of a third threshold value.

In the image forming apparatus 100 of the second embodiment, in a case of the double-sided printing, one image forming medium P to be subjected to the double-sided printing may correspond to two image forming media P. Alternatively, in the image forming apparatus 100, one image forming medium P to be subjected to the double-sided printing may correspond to the number of image forming media which is greater than 1 and smaller than 2. This is because an amount of the heat deprived from the fixing belt 11 when printing on a back surface is not that much compared with that when printing on the front surface as the image forming medium P is warmed when printing on the front surface. Alternatively, in the image forming apparatus 100, one image forming medium P to be subjected to the double-sided printing may correspond to two or more image forming media. This is because that if the image forming medium P when reversed has to pass through the fixing device 108, as the image forming medium P passes through the fixing device 108 three times in total, an amount of heat deprived from the fixing belt 11 is larger than that where a single-side printing is performed twice.

The way to bend the reflector 13 is not limited to pulling the reflector 13. For example, the reflector 13 may be bent by pressing the reflector 13 from the side thereof where the heat source is arranged. For example, the reflector 13 may be bent by pressing the reflector 13 from both ends.

In the above embodiment, the degree of curvature of the reflector 13 is 0 when it is not pulled, i.e., in a state not subjected to a force from the motor 15. However, the degree of curvature of the reflector 13 may be greater than 0 in a state not subjected to a force from the motor. In this case, the motor may apply a force to reduce the degree of curvature of the reflector 13.

The power source for bending the reflector 13 is not limited to the motor.

The image forming apparatus 100 may change the degree of curvature according to air temperature. For example, the image forming apparatus 100 increases the degree of curvature as the air temperature decreases, and reduces the degree of curvature as the air temperature rises. This is because the lower the temperature is, the lower the temperature of the image forming medium P becomes. In such a case, the image forming apparatus 100 includes, for example, a sensor for measuring the air temperature. Alternatively, the image forming apparatus 100 may acquire air temperature information from an external device.

In the above embodiment, the degree of curvature of the reflector 13 is changed where the image forming medium P passes through the fixing device 108 for printing. However, the image forming apparatus 100 may change the degree of curvature of the reflector 13 as well as the above embodiment, even if the image forming medium P passes through the fixing device 108 for purposes other than the printing. For example, the image forming apparatus 100 may change the degree of curvature of the reflector 13 where the image forming medium P passes through the fixing device 108 for decolorizing an image formed with a decolorable recording material.

The image forming apparatus 100 may have a fixing roller instead of the fixing belt 11. The fixing roller performs the same operation as the fixing belt 11 except that the fixing roller has a roller shape rather than a belt shape. The fixing roller heats the image forming medium P passing between the fixing roller and the pressure roller 20. The center of the fixing roller is an example of the first part. The end of the fixing roller is an example of the second part. The fixing roller is an example of the fixing section.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

1-3. (canceled)

4. An image forming apparatus, comprising:
a fixing section configured to heat an image forming medium;
a heater configured to heat the fixing section;
a reflection section configured to reflect radiation from the heater;
a power output section configured to change a degree of curvature of the reflection section; and
a processor configured to control the power output section to change the degree of curvature such that an amount of the radiation reflected by the reflection section becomes larger as a width of the image forming medium passing through the fixing section becomes smaller, and then applied to a first part of the fixing section.

5. The image forming apparatus according to claim 4, wherein the processor is configured to control the power output section to change the degree of curvature such that the amount of the radiation reflected by the reflection section becomes larger as the number of image forming media passing through the fixing section becomes larger, and then applied to the first part of the fixing section.

6. The image forming apparatus according to claim 5, wherein when double-sided printing on the image forming medium, the processor treats a first side of the image forming medium to be subjected to the duplex printing as a first image forming media different from a second side of the image forming medium, which is a second image forming media in terms of conversion of the image forming medium to be subjected to a single-sided printing.

7. The image forming apparatus according to claim 4, further comprising:
a measuring section configured to measure a temperature difference between a temperature of the first part of the fixing section and a temperature of a second part of the fixing section, wherein
wherein the processor is configured to control the power output section to change the degree of curvature so as to increase an amount of the radiation reflected by the reflection section and then applied to the first part if the temperature difference is equal to or greater than a second threshold value after the degree of curvature is changed.

8. The image forming apparatus according to claim 4, further comprising:
a measuring section configured to measure a temperature difference between a temperature of the first part of the fixing section and a temperature of a second part of the fixing section, wherein
wherein the processor is configured to control the power output section to change the degree of curvature so as to decrease an amount of the radiation reflected by the reflection section and then applied to the first part if the temperature difference is equal to or smaller than a third threshold value after the degree of curvature is changed.

9-11. (canceled)

12. A fixing method, including:
heating an image forming medium by a fixing section, with the fixing section being heated by a heater;
providing a reflection section configured for reflecting radiation from the heater, the reflection section having a degree of curvature;
changing the degree of curvature such that an amount of radiation reflected by the reflection section becomes larger as a width of the image forming medium passing through the fixing section becomes smaller, and then applied to a first part of the fixing section.

13. The fixing method according to claim 12, wherein changing the degree of curvature such that the amount of the radiation reflected by the reflection section becomes larger as a number of the image forming medium passing through the fixing section becomes larger, and then applied to the first part of the fixing section.

14. The fixing method according to claim 13, wherein when double-sided printing on the image forming medium, treating a first side of the image forming medium to be subjected to the duplex printing as a first image forming media different from a second side of the image forming medium, which is a second image forming media in terms of conversion of the image forming medium to be subjected to a single-sided printing.

15. The fixing method according to claim 12, further comprising:
measuring a temperature difference between a temperature of the first part of the fixing section and a temperature of a second part of the fixing section,
wherein changing the degree of curvature so as to increase the amount of the radiation reflected by the reflection section and then applied to the first part if the temperature difference is equal to or greater than a second threshold value after the degree of curvature is changed.

16. The fixing method according to claim 12, further comprising:
measuring a temperature difference between a temperature of the first part of the fixing section and a temperature of a second part of the fixing section,
wherein changing the degree of curvature so as to decrease the amount of the radiation reflected by the reflection section and then applied to the first part if the temperature difference is equal to or smaller than a third threshold value after the degree of curvature is changed.
